(19) United States
(12) Patent Application Publication
(10) Pub. No.: US 2024/0085864 A1
(43) Pub. Date: Mar. 14, 2024

(54) Just-In-Time Learning With Variational Autoencoder For Cell Culture Process Monitoring And/Or Control

(71) Applicant: AMGEN INC., Thousand Oaks, CA (US)

(72) Inventors: Mohammad Rashedi, Edmonton (CA); Hamid Khodabandehlou, Thousand Oaks, CA (US); Tony Y. Wang, Tiverton, RI (US); Aditya Tulsyan, Atlanta, GA (US)

(21) Appl. No.: 18/367,580

(22) Filed: Sep. 13, 2023

Related U.S. Application Data
(60) Provisional application No. 63/406,653, filed on Sep. 14, 2022.

(51) Int. Cl. G05B 13/02

(52) U.S. Cl. CPC G05B 13/0265

(57) ABSTRACT

A method for monitoring and/or controlling a biopharmaceutical process includes querying, based on a first spectral scan vector of the biopharmaceutical process, an observation database comprising observation data sets associated with past scans. Each of the observation data sets includes spectral data and a corresponding actual analytical measurement. Querying the observation database includes determining first parameters defining a set of distributions for the first spectral scan vector, and selecting as training data, from among the observation data sets, particular observation data sets based on (i) the first parameters and (ii) other parameters defining respective sets of distributions for the observation data sets. The method also includes calibrating, using the selected training data, a local model specific to the biopharmaceutical process. The method also includes predicting an analytical measurement of the biopharmaceutical process, by using the local model to analyze spectral data generated when scanning the biopharmaceutical process.

### CROSS-REFERENCE TO RELATED APPLICATIONS

Priority is claimed to U.S. Provisional Patent Application No. 63/406,653, filed Sep. 14, 2022, which is hereby incorporated herein by reference in its entirety.

### FIELD OF THE DISCLOSURE

The present application relates generally to the monitoring and/or control of biopharmaceutical processes using spectroscopic techniques, such as Raman spectroscopy, and more specifically relates to the use of Just-in-Time Learning (JITL) models to predict or infer product quality attributes based on spectroscopic scans.

### BACKGROUND

Stable production of biopharmaceutical processes (e.g., biotherapeutic proteins) generally requires that a bioreactor maintain balanced and consistent parameters (e.g., cellular metabolic concentrations), which in turn demands rigorous process monitoring and control. To meet these demands, process analytical technology (PAT) tools are increasingly being adopted. Online monitoring of cell culture pH, dissolved oxygen, and temperature are a few examples of traditional PAT tools that have been used in feedback control systems. More recently, other in-process probes have been investigated and deployed for continuous monitoring of more complex species, such as viable cell density (VCD), glucose, lactate, and other critical cellular metabolites including amino acids, titer, and critical quality attributes.

Raman spectroscopy is a popular PAT tool widely used for online monitoring in biomanufacturing. It is an optical method that enables non-destructive analysis of chemical composition and molecular structure. In Raman spectroscopy, incident laser light is scattered inelastically due to molecular vibration modes. The frequency difference between the incident and scattered photons is referred to as the “Raman shift,” and the vector of Raman shift versus intensity levels (referred to herein as a “Raman spectrum,” a “Raman scan,” or a “Raman scan vector”) can be analyzed to determine the chemical composition and molecular structure of a sample. Applications of Raman spectroscopy in polymer, pharmaceutical, biomanufacturing and biomedical analysis have surged in the past three decades as laser sampling and detector technology have improved. Due to these technological advances, Raman spectroscopy is now a practical analysis technique used both within and outside of the laboratory. Since the application of in-situ Raman measurements in biomanufacturing was first reported, it has been adopted to provide online, real-time predictions of several key process states, such as glucose concentration, lactate concentration, glutamate concentration, glutamine concentration, ammonium concentration, potassium concentration, sodium concentration, viability, VCD, osmolality, and titer. These predictions are typically based on a calibration model, or a soft-sensor model that is built in an offline setting. The model is built using analytical measurements from an analytical instrument. Partial least squares (PLS) and multiple linear regression modeling methods are commonly used to correlate the Raman spectra to the analytical measurements. These models typically require pre-processing (filtering) of the Raman scans prior to calibrating against the analytical measurements. Once a calibration model is trained, the model is implemented in a real-time setting to provide in-situ measurements for process monitoring and/or control.

Raman model calibration for biopharmaceutical applications is nontrivial, as biopharmaceutical processes typically operate under stringent constraints and regulations. Raman model calibration in the biopharmaceutical industry has conventionally involved running multiple campaign trials to generate relevant data that is used to correlate the Raman spectra to the analytical measurement(s). These trials are both expensive and time-consuming, as each campaign may last from two to four weeks in a laboratory setting. Furthermore, only limited samples may be available for the analytical instruments (e.g., to ensure that a lab-scale bioreactor maintains a healthy mass of viable cells). In fact, it is not uncommon to have only one or two measurements available each day from in-line or offline analytical instruments. To further exacerbate the situation, the models are tied to a specific process, the specific formula or profile of the bioreactor media, and the specific operating conditions. Thus, if any of the aforementioned variables were to change, the models may need to be re-calibrated based on new data. Both Raman model calibration and model maintenance require significant resource allocations and are typically performed in an offline setting.

To address the issue of model performance degrading over time due to process variability, a variety of soft sensing techniques, such as moving window, time difference, and recursive modeling, have been implemented. See Qin et al., Comput. Chem. Eng., 22, 503-514, Recursive PLS Algorithms for Adaptive Data Modeling(1998); Kaneko et al., Ind. Eng. Chem. Res., 54, 700-704, Moving Window and Just-In-Time Soft Sensor Model Based on Time Differences Considering a Small Number of Measurements (2015). However, none of these techniques adequately accounts for or addresses abrupt changes in industrial processes.

To better account for abrupt changes, a Just-In-Time Learning (JITL) technique has been proposed for automatic calibration and assessment of Raman models. See Tulsyan et al., AICHE Journal, e17210, Spectroscopic Models for Real-Time Monitoring of Cell Culture Processes Using Spatiotemporal Just-In-Time Gaussian Processes (2020); Tulsyan et al., Biotechnology and Bioengineering, 116(10), 2575-2586, A Machine Learning Approach to Calibrate Generic Raman Models for Real-Time Monitoring of Cell Culture Processes (2019); Tulsyan et al., Biotechnology and Bioengineering, 117(2), 406-416, Automatic Real-Time Calibration, Assessment, and Maintenance of Generic Raman Models for Online Monitoring of Cell Culture Processes (2020). JITL is an instant modeling platform based on local modeling and database sampling technology. Unlike other machine-learning methods, JITL generally assumes that all available observations are stored in a central observation database, and local models are dynamically built in real-time based upon a query sample (e.g., a new Raman scan), ideally using the most “similar” or relevant data from the observation database. This allows for good approximation of complicated process dynamics using relatively simple local models. Under the JITL framework, a library may contain spectral data not only for a single process operating under specific operating conditions, but also data for different processes, different media profiles, and/or different operating conditions. This can significantly reduce the time required to calibrate and maintain models, especially for pipeline drugs that may have little or no past production history.

Conventionally in JITL, “similar” historical samples are identified in the observation database based on Euclidean distance, angle, or correlation. See Quan et al., Applied Soft Computing, 10, 562-566, Weighted Least Squares Support Vector Machine Local Region Method for Nonlinear Time Series Prediction (2010); Cheng et al., Chemical Engineering Science, 59(13), 2801-2810, A New Data-Based Methodology for Nonlinear Process Modeling (2004); Fujiwara et al., AIChE Journal, 55(7), 1754-1765, Softsensor Development Using Correlation-Based Just-In-Time Modeling (2009). All of these techniques find the historical samples most relevant to the query sample in a deterministic and point-to-point manner. See Z. Q. Ge et al., Chemometr. Intell. Lab. Syst., 104(13), 306-317, A Comparative Study of Just-In-Time-Learning Based Methods for Online Soft Sensor Modeling (2010). However, Raman scan results can reflect considerable uncertainty, which deterministic techniques fail to take into account. Thus, the uncertainty in samples/scans can lead to relatively poor selections of “similar” historical samples and, as a result, relatively poor predictive performance of the JITL local models that are built based on the selected historical samples.

### BRIEF SUMMARY

To address the aforementioned problems pertaining to Just-In-Time Learning (JITL) techniques for biopharmaceutical applications, systems and methods disclosed herein account for uncertainties in spectroscopic measurements by using distributions, rather than just deterministic values, to identify “similar” historical samples (e.g., similar Raman scans) in an observation database. In particular, a computing system may use historical samples to train/generate a variational autoencoder (VAE) that includes an encoder and a decoder. The encoder transforms each input sample (scan) to a lower-dimensionality latent space representation comprising parameters (e.g., means and variances) that define distributions of the input sample, and the decoder attempts to re-create the full input sample by sampling from distributions in the latent space The computing system (or another computing system) can then use the encoder portion of the trained VAE to determine parameters defining a set of distributions for each historical sample (e.g., each historical Raman scan) and parameters defining a set of distributions for a sample of interest (e.g., a new, real-time Raman scan), and use the determined parameters to identify/select those historical samples that have distributions that are most similar to the sample of interest. The selection stage may include using multivariate Kullback-Leibler (KL) divergence to identify the most similar historical samples, for example. In some embodiments, the encoder includes exactly one hidden layer.

In addition to the benefits of JITL (e.g., preventing model degradation over time and tracking abrupt changes in biopharmaceutical processes), integration of VAE into JITL helps to identify more relevant JITL training samples based on sample distributions. By selecting better historical samples to train/build the local model, the local model can better predict analytical measurements such as metabolite concentrations, viable cell density, and so on.

### BRIEF DESCRIPTION OF THE DRAWINGS

The skilled artisan will understand that the figures, described herein, are included for purposes of illustration and are not limiting on the present disclosure. The drawings are not necessarily to scale, emphasis instead being placed upon illustrating the principles of the present disclosure. It is to be understood that, in some instances, various aspects of the described implementations may be shown exaggerated or enlarged to facilitate an understanding of the described implementations. In the drawings, like reference characters throughout the various drawings generally refer to functionally similar and/or structurally similar components.

FIG. 1 is a simplified block diagram of an example Raman spectroscopy system that incorporates VAE-JITL to predict analytical measurements of biopharmaceutical processes for monitoring purposes.

FIG. 2 is a simplified block diagram of an example Raman spectroscopy system that incorporates VAE-JITL to predict analytical measurements of biopharmaceutical processes for closed-loop control of glucose concentration.

FIG. 3 depicts an example data flow that may occur when analyzing a biopharmaceutical process using a JITL technique, such as VAE-JITL.

FIG. 4 depicts an example VAE, the encoder portion of which may be used by the VAE-JITL predictor application of FIG. 1 or FIG. 2 to select historical scans from the observation database of FIG. 1 or FIG. 2 based on a query sample.

FIG. 5 depicts an example VAE-JITL process that may be implemented by the computing system of FIG. 1 or FIG. 2.

FIGS. 6A and 6B depict an example, downsampled Raman scan before and after baseline correction, respectively.

FIGS. 7A-J depict examples of VAE-JITL prediction performance relative to linear JITL prediction performance and measured values, for various types of analytical measurements.

FIG. 8 is a flow diagram of an example method for analyzing a biopharmaceutical process using VAE-JITL.

### DETAILED DESCRIPTION

The various concepts introduced above and discussed in greater detail below may be implemented in any of numerous ways, and the described concepts are not limited to any particular manner of implementation. Examples of implementations are provided for illustrative purposes.

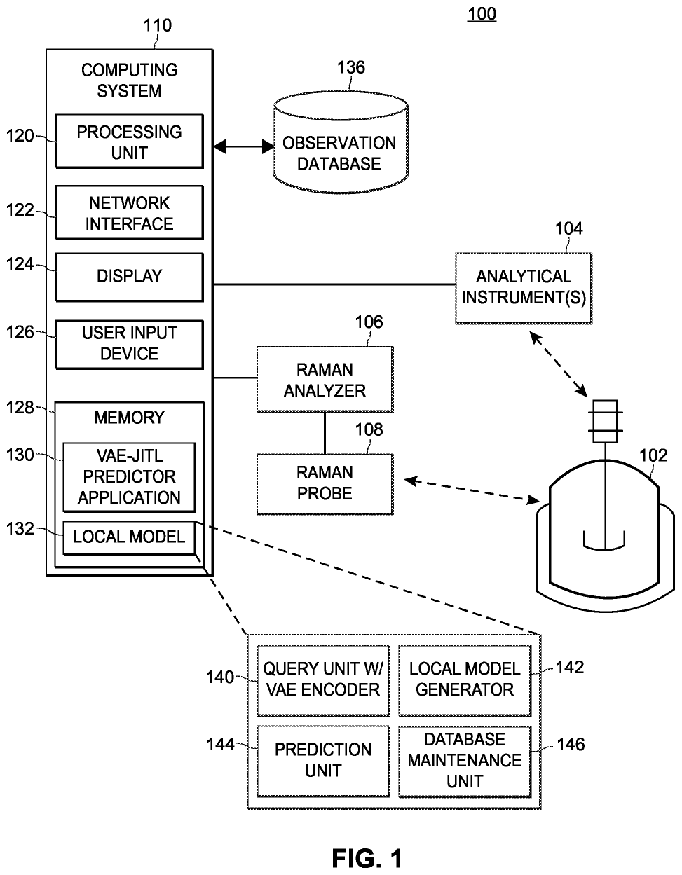

FIG. 1 is a simplified block diagram of an example Raman spectroscopy system 100 that may be used to predict analytical measurements of biopharmaceutical processes. While FIG. 1 depicts a system 100 that implements Raman spectroscopy techniques, it is understood that, in other embodiments, system 100 may implement other spectroscopy techniques suitable for analyzing biopharmaceutical processes, such as near-infrared (NIR) and mass spectroscopy, for example. For ease of explanation, the following description (for all figures) refers specifically to Raman spectroscopy embodiments.

System 100 includes a bioreactor 102, one or more analytical instruments 104, a Raman analyzer 106 with Raman probe 108, and a computing system 110. Bioreactor 102 may be any suitable vessel, device, or system that supports a biologically active environment, which may include living organisms and/or substances derived therefrom (e.g., a cell culture) within a media. Bioreactor 102 may contain recombinant proteins that are being expressed by the cell culture, e.g., such as for research purposes, clinical use, commercial sale or other distribution. Depending on the biopharmaceutical process being monitored, the media may include a particular fluid (e.g., a “broth”) and specific nutrients, and may have a target pH level or range, a target temperature or temperature range, and so on. Collectively, the contents and parameters/characteristics of media are referred to herein as the “media profile.”

Analytical instrument(s) 104 may be any in-line, at-line, and/or offline instrument, or instruments, configured to measure one or more characteristics or parameters of the biologically active contents within bioreactor 102, based on samples taken therefrom. For example, analytical instrument(s) 104 may measure one or more media component concentrations, such as metabolite levels (e.g., glucose, lactate, glutamate, glutamine, ammonium, pCO2, pO2, Na+, K+, etc.) and/or amino acid levels. Additionally, or alternatively, analytical instrument(s) 104 may measure osmolality, viability, viable cell density (VCD), titer, critical quality attributes, cell state (e.g., cell cycle), and/or other characteristics or parameters associated with the contents of bioreactor 102. As a more specific example, samples may be taken, spun down, purified by multiple columns, and run through a first analytical instrument 104 (e.g., a high performance liquid chromatography (HPLC) or ultra high performance liquid chromatography (UPLC) instrument), followed by a second analytical instrument 104 (e.g., a mass spectrometer), with both the first and second analytical instruments 104 providing analytical measurements. One, some, or all of analytical instrument(s) 104 may use destructive analysis techniques.

Raman analyzer 106 may include a spectrograph device coupled to Raman probe 108 (or, in some implementations, multiple Raman probes). Raman analyzer 106 may include a laser light source that delivers the laser light to Raman probe 108 via a fiber optic cable, and may also include a charge-coupled device (CCD) or other suitable camera/recording device to record signals that are received from Raman probe 108 via another channel of the fiber optic cable, for example. Alternatively, the laser light source may be integrated within Raman probe 108 itself. Raman probe 108 may be an immersion probe, or any other suitable type of probe (e.g., a reflectance probe and transmission probe).

Collectively, Raman analyzer 106 and Raman probe 108 are configured to non-destructively scan the biologically active contents during the biopharmaceutical process within bioreactor 102 by exciting, observing, and recording a molecular “fingerprint” of the biopharmaceutical process. The molecular fingerprint corresponds to the vibrational, rotational and/or other low-frequency modes of molecules within the biologically active contents within the biopharmaceutical process when the bioreactor contents are excited by the laser light delivered by Raman probe 108. As a result of this scanning process, Raman analyzer 106 generates Raman scan vectors that each represent intensity as a function of Raman shift (frequency).

Computing system 110 may be a single computing device, or include more than one co-located and/or distributed computing devices. Computing system 110 is coupled to Raman analyzer 106 and analytical instrument(s) 104, and is generally configured to analyze the Raman scan vectors generated by Raman analyzer 106 in order to predict one or more analytical measurements of the biopharmaceutical process. For example, computing system 110 may analyze the Raman scan vectors to predict the same type(s) of analytical measurement(s) that are made by analytical instrument(s) 104. As a more specific example, computing system 110 may predict glucose concentrations, while analytical instrument(s) 104 actually measure glucose concentrations. However, whereas analytical instrument(s) 104 may make relatively infrequent, “offline” analytical measurements of samples extracted from bioreactor 102 (e.g., due to limited quantities of the biopharmaceutical process, and/or due to the higher cost of making such measurements, etc.), computing system 110 may make relatively frequent, “online” predictions of analytical measurements in real-time. In one embodiment, Raman scans are collected every 30 minutes, which analytical measurements are made every 24 hours (i.e., such that each day exactly one Raman scan is performed at the same time as an analytical measurement). It is understood that, as used herein, terms such as “predict” or “prediction” do not necessarily refer to determination or estimation of a future value, and can instead refer to the inference of a current value.

In the example embodiment shown in FIG. 1, computing system 110 includes a processing unit 120, a network interface 122, a display 124, a user input device 126, and a memory 128. Processing unit 120 includes one or more processors, each of which may be a programmable microprocessor that executes software instructions stored in memory 128 to execute some or all of the functions of computing system 110 as described herein. Alternatively, one, some or all of the processors in processing unit 120 may be other types of processors (e.g., application-specific integrated circuits (ASICs), field-programmable gate arrays (FPGAs), etc.), and the functionality of computing system 110 as described herein may instead be implemented, in part or in whole, in hardware. Memory 128 may include one or more physical memory devices or units containing volatile and/or non-volatile memory. Any suitable memory type or types may be used, such as read-only memory (ROM), random-access memory (RAM), solid-state drives (SSDs), hard disk drives (HDDs), and so on.

Network interface 122 may include any suitable hardware (e.g., front-end transmitter and receiver hardware), firmware, and/or software configured to communicate with external devices and/or systems (e.g., analytical instrument(s) 104, Raman analyzer 106, and/or observation database 136) via one or more networks using one or more communication protocols. For example, network interface 122 may be or include an Ethernet interface, and/or include a wireless local area network (LAN) interface, etc.

Display 124 may use any suitable display technology (e.g., LED, OLED, LCD, etc.) to present information to a user, and user input device 126 may be a keyboard or other suitable input device. In some embodiments, display 124 and user input device 126 are integrated within a single device (e.g., a touchscreen display). Generally, display 124 and user input device 126 may combine to enable a user to interact with graphical user interfaces (GUIs) provided by computing system 110, e.g., for purposes such as manually monitoring various processes being executed within system 100. In some embodiments, however, computing system 110 does not include display 124 and/or user input device 126, or one or both of display 124 and user input device 126 are included in another computer or system that is communicatively coupled to computing system 110 (e.g., in some embodiments where predictions are sent directly to a control system that implements closed-loop control).

Memory 128 stores the instructions of one or more software applications, including a variational autoencoder (VAE) Just-In-Time-Learning (JITL) predictor application 130 (also referred to herein as “VAE-JITL predictor application 130”). VAE-JITL predictor application 130, when executed by processing unit 120, is generally configured to predict analytical measurements of the biopharmaceutical process in bioreactor 102 by using the encoder of a VAE to select historical samples/scans from observation database 136, generating/building/calibrating a local model 132 using the selected samples, and using the calibrated local model 132 to analyze Raman scan vectors generated by Raman analyzer 106. Depending on the frequency at which Raman analyzer 106 generates such scan vectors, VAE-JITL predictor application 130 may predict analytical measurements on a periodic or other suitable time basis. Raman analyzer 106 may itself control when scan vectors are generated, or computing system 110 may trigger the generation of scan vectors by sending a command to Raman analyzer 106. VAE-JITL predictor application 130 may predict only a single type of analytical measurement based on each scan vector (e.g., only glucose concentration), or may predict multiple types of analytical measurements based on each scan vector (e.g., glucose concentration and viable cell density). In other embodiments, multiple different VAE-JITL predictor applications (e.g., each similar to VAE-JITL predictor application 130) each generate a different local model to predict a different type of analytical measurement, all based on the same scan vector. VAE-JITL predictor application 130 and local model 132 are discussed in further detail below.

Observation database 136 stores historical observation data sets associated with past observations. The observations/data sets may be curated, e.g., by removing outliers and imputing missing data. Each observation data set in observation database 136 may include spectral data (e.g., a Raman scan vector of the sort produced by Raman analyzer 106) and one or more corresponding analytical measurements (e.g., one or more measurements of the sort(s) produced by analytical instrument(s) 104). Depending on the embodiment and/or scenario, the past observations may have been collected for a number of different biopharmaceutical processes, under a number of different operation conditions (e.g., different metabolite concentration set points), and/or with a number of different media profiles (e.g., different fluids, nutrients, pH levels, temperatures, etc.). Generally, it may be desirable to have observation database 136 represent a broadly diverse array of processes, operating conditions, and media profiles. Observation database 136 may or may not store information indicative of those processes, cell lines, proteins, metabolites, operating conditions, and/or media profiles, however, depending on the embodiment (as discussed further below).

It is understood that other architectures, configurations, and/or components may be used instead of those shown in FIG. 1. For example, observation database 136 may be maintained and/or accessed by a database server separate from computing system 110, in which case some of the functionality represented in FIG. 1 (e.g., some functionality of query unit 140) may instead be performed by the database server. Such an architecture may be desirable in order to collect a larger number of observation data sets for storage in observation database 136 (e.g., if the database server is connected to numerous computing systems each similar to computing system 110). As another example of a different architecture, a different computer (not shown in FIG. 1) may transmit measurements provided by analytical instrument(s) 104 to computing system 110.

During run-time operation of system 100, Raman analyzer 106 and Raman probe 108 are used to scan (i.e., generate Raman scan vectors for) a biopharmaceutical process in bioreactor 102, and the Raman scan vector(s) is/are then transmitted from Raman analyzer 106 to computing system 110. Raman analyzer 106 and Raman probe 108 may provide scan vectors to support predictions (made by VAE-JITL predictor application 130) according to a predetermined schedule of monitoring periods, such as once per minute, or once per hour, etc. Alternatively or additionally, Raman scans may be collected, and predictions may be made based on those scans, at irregular intervals (e.g., in response to a certain process-based trigger, such as a change in measured pH level and/or temperature), such that each monitoring period has a variable or uncertain duration.

A query unit 140 of VAE-JITL predictor application 130 uses the scan vector(s) received for a monitoring period to generate a query point that will be used to query observation database 136. In some embodiments, the query point (i.e., the data defining the query point, also referred to herein as a “query sample”) includes only data representing the Raman scan vector that was received from Raman analyzer 106 (e.g., intensity/frequency tuples that comprise the scan vector). In other embodiments, the query point used to query the query observation database 136 also includes one or more other types of information. For example, the query point may also include data representing operating conditions associated with the process (e.g., a metabolite concentration set point in a control system, or a laser light wavelength and/or intensity associated with Raman analyzer 106 or Raman probe 108, etc.), data representing the media profile for the biopharmaceutical process media (e.g., fluid type, nutrient types or concentrations, pH level, etc.), and/or other data (e.g., indicators of cell lines, proteins or metabolites associated with the biopharmaceutical process).

Generally, the query points may include data representing the same vectors, parameters, and/or classifications that local model 132 uses as inputs (i.e., as the feature set of local model 132). Use of a number of different data types for the feature set (e.g., operating conditions, media profile data, etc., as described above) may improve accuracy of the analytical measurement predictions made by local model 132. However, because each observation data set in observation database 136 would generally need to include the same vector, parameters, and/or classifications as the feature set, it may be preferable to limit the query point, and the feature set/inputs of local model 132, to only include the Raman scan vector. This may provide various benefits, such as allowing the collection of more information for storage in observation database 136, and/or simplifying the collection of that information. If only Raman scan vectors are used, for example, observation data sets may be included in observation database 136 even if little or nothing is known about the processes, cell lines, proteins, metabolites, operating conditions, and/or media profiles that existed when the data sets were collected.

Query unit 140 then queries observation database 136 using the generated query point. After receiving the query point/sample, query unit 140 uses the query sample to select relevant observation data sets from observation database 136 that will be particularly useful as training data for local model 132. In some embodiments, VAE-JITL predictor application 130 pre-processes the Raman scan vector to generate the query sample. For example, as discussed further below, VAE-JITL predictor application 130 may generate the query sample by downsampling the Raman scan vector, performing baseline correction on the downsampled vector, and/or normalizing the downsampled and baseline-corrected vector.

To determine which observation data sets are most “relevant” (most similar, most correlated, etc.) to the query sample, query unit 140 uses an encoder of a variational autoencoder (VAE). The VAE may have previously been trained (e.g., by VAE-JITL predictor application 130 or another application of computing system 110 or another computing system) based on a number of Raman scans (e.g., downsampled, baseline-corrected, and/or normalized Raman scans) from observation database 136 and/or one or more other sources. Once the VAE is trained, the encoder layer of the VAE can capture features of an input Raman scan that represent, with lower dimensionality, the input Raman scan. Specifically, the encoder layer (also referred to herein simply as the “encoder”) of the trained VAE can generate parameters that define a number of distributions representative of the Raman scan that was input to the encoder. For example, the encoder may generate a mean and a variance for each of a number of (e.g., 2, 3, 5, 10, etc.) normal (or approximately normal) distributions for a given input Raman scan. The parameters defining a distribution, or a set of distributions, are at times referred to herein as “distribution parameters.”

In identifying the most relevant data sets, query unit 140 generates (1) distribution parameters for each of a plurality of (e.g., all of) Raman scan vectors stored in observation database 136, and (2) distribution parameters for the query sample. It is understood that, prior to inputting a historical Raman scan vector into the encoder, and prior to inputting the Raman scan vector of interest into the encoder, each Raman scan vector may be pre-processed (e.g., downsampled, baseline-corrected, and/or normalized). Query unit 140 may generate distribution parameters for the Raman scan vectors stored in observation database 136 at any time (e.g., offline, prior to run-time operation of bioreactor 102, or during run-time operation). However, query unit 140 generates the distribution parameters for the query sample in real-time (e.g., during run-time operation of bioreactor 102, as scans are provided by Raman analyzer 106). Once distribution parameters are available for both the historical scans and the new (query sample) scan, query unit 140 can select particular data sets/scans from observation database 136 based on those distribution parameters. For example, query unit 140 may select the most relevant/similar scans from observation database 136 by selecting those scans that have the lowest multivariate KL divergence with the query sample. VAE and multivariate KL divergence are discussed in further detail below.

In some embodiments, query unit 140 also considers one or more other factors, in addition to distribution parameters, when selecting relevant scans. For example, to better adapt to time-varying process changes, query unit 140 may further consider the timing or order of samples in observation database 136 (e.g., which samples are most recent). To this end, in addition to using VAE-JITL to select historical samples based on distribution parameters, query unit 140 may incorporate the “adaptive” JITL (A-JITL) or “spatiotemporal” JITL (ST-JITL) approaches described in U.S. Patent Publication No. 2022/0128474 (Tulsyan, “Automatic Calibration and Automatic Maintenance of Raman Spectroscopic Models for Real-Time Predictions”), the entirety of which is hereby incorporated herein by reference. More generally, any of the techniques described in U.S. Patent Publication No. 2022/0128474 may be used, so long as they are compatible with, and used in addition to, VAE-JITL techniques as described herein.

In some embodiments, query unit 140 selects only a predetermined number of relevant observation data sets in response to a single query, or selects no more than some maximum allowed number of relevant observation data sets, to ensure that only a relatively small subset of all datasets within observation database 136 is retrieved. In other embodiments, however, query unit 140 can select any number of relevant observation data sets, so long as suitable relevancy criteria are satisfied (e.g., so long as the multivariate KL divergence is below a predetermined threshold) for each selected data set.

After identifying the relevant/similar observation data sets (each of which may or may not correspond to the same process conditions as the biopharmaceutical process in bioreactor 102 that is currently being monitored), query unit 140 provides or indicates those data sets (e.g., the Raman scan vectors and corresponding analytical measurement(s)) to local model generator 142. Local model generator 142 then uses the relevant data sets as training data to calibrate local model 132. That is, local model generator 142 uses the Raman scan vector (and possibly other data) associated with each observation data set (possibly after some pre-processing) as a feature set, and uses the analytical measurement(s) associated with the same observation data set as a label for that feature set.

In some embodiments, the local model 132 built by local model generator 142 is a Gaussian process model, in order to efficiently capture complex, nonlinear process dynamics and readily adapt to virtually any process changes. Unlike partial least squares (PLS) and principal component regression (PCR) models, Gaussian process models use non-parametric methods, and are far more capable of capturing complex nonlinear correlations between the Raman scan vectors and the analytical measurements, even when using a very limited number of training samples. This can be particularly important in scenarios where new products or processes correspond to only a limited number of data sets in observation database 136. In such scenarios, a Gaussian process model is generally able to extract the most information from those limited data sets, in conjunction with the other relevant data sets that query unit 140 selects from observation database 136. In other embodiments, however, local model generator 142 may instead build any other suitable type of machine-learning model (e.g., a recursive neural network, a convolutional neural network, etc.), so long as the training time does not exceed the minimum desired duration of a monitoring period. Local model generator 142 may also build local model 132 such that local model 132 can output credibility bounds, or some other suitable indicator of prediction confidence (e.g., a confidence score). At least as compared to PLS and PCR models, Gaussian process models are particularly well-suited for providing credibility bounds around the analytical measurement predictions. While various advantages of Gaussian process models over PLS and PCR models have been described, it is understood that, in some embodiments, local model generator 142 may use PLS, PCR, or other modeling methods to build local model 132 (e.g., to speed up calibration, or for easier deployment in an industrial setting, etc.).

Local model generator 142 may build local model 132 in an online, real-time manner, such that prediction unit 144 can then use the trained local model 132 to predict one or more analytical measurements of the biopharmaceutical process by processing the same Raman scan vector that query unit 140 had used to generate the query point. Indeed, in some embodiments, query unit 140 may perform a new query, and local model generator 142 may generate a new version of local model 132, each and every time that Raman analyzer 106 provides a new Raman scan vector to computing system 110. In other embodiments, however, query unit 140 performs a new query (and local model generator 142 generates a new version of local model 132) on a less frequent basis, such as once every 10 predictions/monitoring periods, or once every 100 predictions/monitoring periods, etc.

Database maintenance unit 146 may also cause analytical instrument(s) 104 to periodically collect one or more actual analytical measurements, at a significantly lower frequency than the monitoring period of Raman analyzer 106 (e.g., only once or twice per day, etc.). The measurement(s) by analytical instrument(s) 104 may be destructive, in some embodiments, and require permanently removing a sample from the process in bioreactor 102. At or near the time that database maintenance unit 146 causes analytical instrument(s) 104 to collect and provide the actual analytical measurement(s), database maintenance unit 146 may also cause Raman analyzer 106 to provide one or more Raman scan vectors. Database maintenance unit 146 may then cause observation database 136 to store the Raman scan vector(s) as new observation data set(s). Observation database 132 may be updated according to any suitable timing, which may vary depending on the embodiment. If analytical instrument(s) 104 output(s) actual analytical measurements within seconds of measuring a sample, for instance, observation database 132 may be updated with new measurements almost immediately as samples are taken. In certain other embodiments, however, the actual analytical measurements may be the result of minutes, hours or even days of processing by one or more of analytical instrument(s) 104, in which case observation database 132 is not updated until after such processing has been completed. In still other embodiments, new observation datasets may be added to observation database 132 in an incremental manner, as different ones of analytical instruments 104 complete their respective measurements.

Thus, observation database 136 may provide a “dynamic library” of past observations that local model generator 142 may draw upon for model training. In some embodiments, the latest analytical measurement(s) is/are always added to observation database 136, and local model generator 142 may always use the most recent observation data set(s) in observation database 136 when calibrating local model 132. This may allow local model 132 to encode the process information from the recent past and to quickly adapt to new conditions, or quickly adapt to new process conditions with no history.

In some embodiments, only a subset of the scans in observation database 136 have corresponding actual analytical measurements, in which case the VAE may be trained using all or most of the data sets, while the local model 132 is trained using only data sets selected from among those data sets that have a corresponding actual analytical measurement (with the analytical measurement being used as a label when training local model 132).

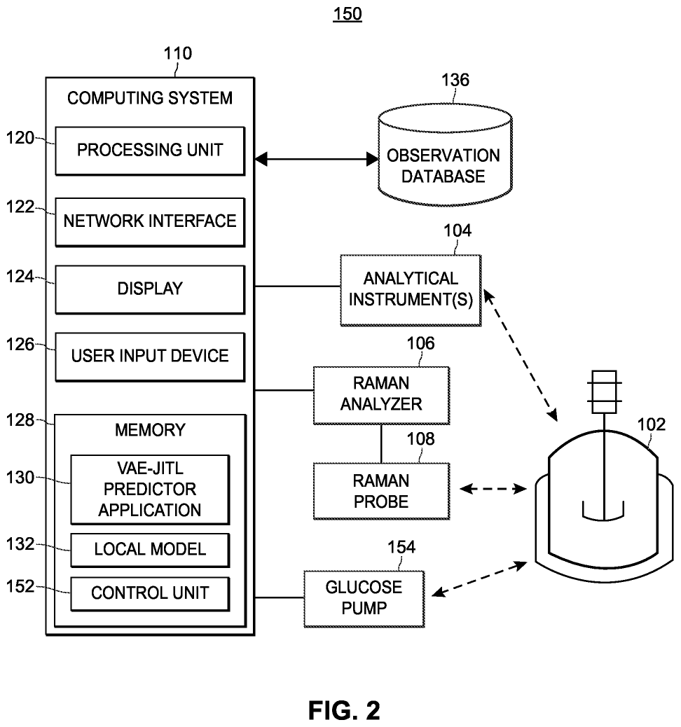

Some or all of the processes described above may be repeated a number of times over the life of the biopharmaceutical process in the bioreactor, in order to continuously monitor the process using a local model for which both calibration and maintenance are fully automated and in real-time. The analytical measurement(s) may be predicted for various purposes, depending on the embodiment and/or scenario. For example, certain parameters may be monitored (i.e., predicted) as a part of a quality control process, to ensure that the process still complies with relevant regulations. As another example, one or more parameters may be monitored/predicted to provide feedback in a closed-loop control system. For example, FIG. 2 depicts a system 150 that is similar to system 100, but attempts to control a glucose concentration in the biopharmaceutical process (i.e., attempts to make the predicted glucose concentration match a desired set point, within some acceptable tolerance). It is understood that, in other embodiments, system 150 may instead (or also) be used to control process parameters other than glucose level, or to control glucose level based on predictions of one or more other process parameters (e.g., lactate level). In FIG. 2, the same reference numbers are used to indicate the corresponding components from FIG. 1. For example, VAE-JITL predictor application 130 of FIG. 2 may be the same as VAE-JITL predictor application 130 of FIG. 1 (with the various units of VAE-JITL predictor application 130 not being shown in FIG. 2 for purposes of clarity).

As seen in FIG. 2, within system 150, memory 128 also stores a control unit 152. Control unit 152 is configured to control a glucose pump 154, i.e., to cause glucose pump 154 to selectively introduce additional glucose into the biopharmaceutical process within bioreactor 102. Control unit 152 may comprise software instructions that are executed by processing unit 120, for example, and/or appropriate firmware and/or hardware. In some embodiments, control unit 152 implements a model predictive control (MPC) technique, using glucose concentrations as inputs in a closed-loop architecture. In embodiments where local model 132 provides credibility bounds or other confidence indicators with each prediction (e.g., in certain embodiments where local model 132 is a Gaussian process model), control unit 152 may also accept the confidence indicators as inputs. For example, control unit 152 may only generate control instructions for glucose pump 154 based on glucose concentration predictions having a sufficiently high confidence indicator (e.g., only based on predictions associated with credibility bounds that do not exceed some percentage or absolute measurement range, or only based on predictions associated with confidence scores over some minimum threshold score, etc.), or may increase and/or reduce the weight of a given prediction based on its confidence indicator, etc.

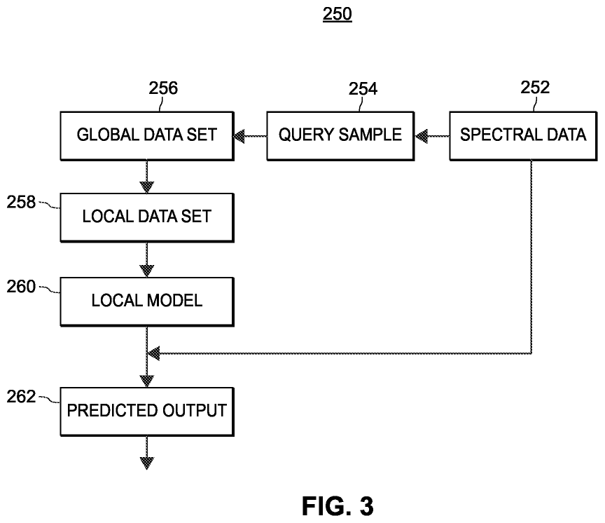

Turning now to FIG. 3, an example data flow 250 that may occur when analyzing a biopharmaceutical process using a JITL technique, such as the VAE-JITL techniques described herein, is shown. The data flow 250 may occur within system 100 of FIG. 1 or system 150 of FIG. 2, for example. In the data flow 250, spectral data 252 is provided by a spectrometer/probe. For example, spectral data 252 may include a Raman scan vector generated by Raman analyzer 106, or an NIR scan vector, etc. A query sample 254 is generated (e.g., by query unit 140) based on spectral data 252, and is used to query a global data set 256, which may include all of the observation data sets in observation database 136, for example. The query unit 140 may generate the query sample 254 by pre-processing the spectral data 252, or by simply using the spectral data 252 as the query sample 254. Based on the query, a local data set 258 is identified within global data set 256. In VAE-JITL, local data set 258 is selected using the encoder of a VAE, as discussed above and in further detail below. Local data set 258 is then used as training data (e.g., by local model generator 142) to calibrate a local model 260 (e.g., local model 132). Local model 260 is then used (e.g., by prediction unit 144) to predict an output (analytical measurement) 262, such as a media component (e.g., glucose or other metabolite, or amino acid, etc.) concentration, viability, viable cell density, titer, etc., and possibly also output credibility bounds or another suitable confidence indicator. The process of building/calibrating local model 260 (e.g., local model 132), after the query is conducted, may be performed as described mathematically in U.S. Patent Publication No. 2022/0128474, for example.

An autoencoder is a neural network that is trained to reconstruct the inputs through an encoder layer and a decoder layer. The encoder layer creates a latent space that represents the main structured part of input information. The decoder uses this information to reconstruct the input layer by minimizing a reconstruction error. However, training an autoencoder with no information loss between the input and output layers results in severe overfitting to the data set, which prevents the autoencoder from generating new content. To resolve this issue, the query unit 140 uses a VAE with a regularized latent space, where a distribution is sampled instead of a fixed point.

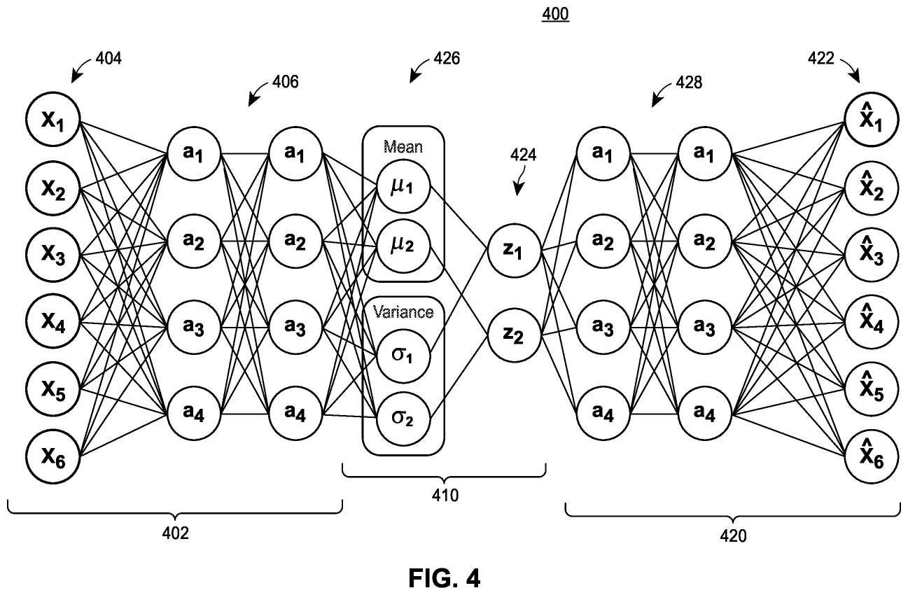

FIG. 4 depicts an example VAE 400. VAE 400 includes an encoder 402 comprising hidden layers 406 that operate on inputs (scan values) applied at an input layer 404 and transform the inputs to a latent space 410. A decoder 420 of the VAE 400 attempts to reconstruct the inputs at an output layer 422, by processing samples 424 in the latent space 410 using hidden layers 428. The VAE-JITL predictor application 130 or another application and/or computing system may build the VAE 400, after which query unit 140 may use encoder 402 (without decoder 420) to select similar historical samples/scans, as described herein. As seen in FIG. 4, encoder 402 produces/outputs parameters 426 that define latent space distributions (e.g., in this example, mean and variance values of latent space distributions) for the scan applied as input at the input layer 404. The latent space distribution is Pr[Z][X], where Z is a sample representing approximate information of the latent space 410. The desired objective in VAE is to have this distribution be as similar as possible to a unique distribution, such as a standard normal distribution, i.e., N(0, I). The similarity of the latent space distributions Pr[Z][X] and the normal distribution N(0, I) is then obtained through the calculation of multivariate Kullback-Leibler (KL) divergence, e.g., as described in Guo et al., Chemometr. Intell. Lab. Syst., 197, A Deep Learning Just-In-Time-Learning Modeling Approach for Soft Sensor Based on Variational Autoencoder (2020). Thus, the VAE loss function is comprised of a reconstruction loss term together with a regularization term as follows:

Loss=∥X−D(Z)∥²+KL[N(μ,Σ)N,(0,I)] (Equation 1)

By minimizing Equation 1 through VAE training based on historical Raman scans, the weights of the VAE 400 network can be optimized. Thereafter, query unit 140 can use the trained encoder 402 as a pre-processing step for feature extraction in VAE-JITL (i.e., prior to determining which historical Raman scans are most similar to the Raman scan of interest). As noted above, while Raman spectroscopy provides signals with many features (each corresponding to a different Raman shift), the Euclidean or point-to-point distance of these features may not be the best criterion to find the most similar samples. Integrating JITL with the VAE encoder 402, however, can allow a better combination of features from the data set samples to be selected for the query point x^{q} ∈ [symbol] for model development. In order to find the most similar samples to the query sample, encoder 402 maps each input x ∈ [symbol] to the latent space z ∈ [symbol] with 1<d. Thereafter, by generating a multivariate normal distribution, Z˜N (μ, Σ), for each Raman scan in the latent space, the most similar scans will have the minimum multivariate KL-divergence (MKL) with the query sample. Hence, the distance function to be minimized is:

Dist(xⁱ,x^{q})=MKL[N(μⁱ,Σⁱ),N(μ^{q},Σ^{q})] (Equation 2)

In some embodiments, VAE 400 may have a different architecture than that shown in FIG. 4. For example, encoder 402 and decoder 420 may each include exactly one hidden layer. In other embodiments, encoder 402 and decoder 420 do not include hidden layers, or each include more than one hidden layer. As other examples, any of the layers shown may include more nodes than are shown in FIG. 2, encoder 402 may produce parameters 426 for more than the two distributions shown in FIG. 4 (e.g., for 3, 4, 5, 10, etc., distributions), and so on.

Once the Raman scans close to the query sample are extracted and collected in a local set (i.e., [symbol] ={(x^{k},y^{k}),k=1, . . . , K}with K being the number of samples needed for model development), local model generator 142 uses the scans x^{k} and the corresponding target variables y^{k} to build the local model 132 (e.g., based on Gaussian process regression). See Tulsyan et al., AICHE Journal, e17210, Spectroscopic Models for Real-Time Monitoring of Cell Culture Processes Using Spatiotemporal Just-In-Time Gaussian Processes (2020); Williams, Learning in Graphical Models, 599-621 (1998). Finally, prediction unit 144 uses the local model 132 to predict the analytical measurement for the query sample.

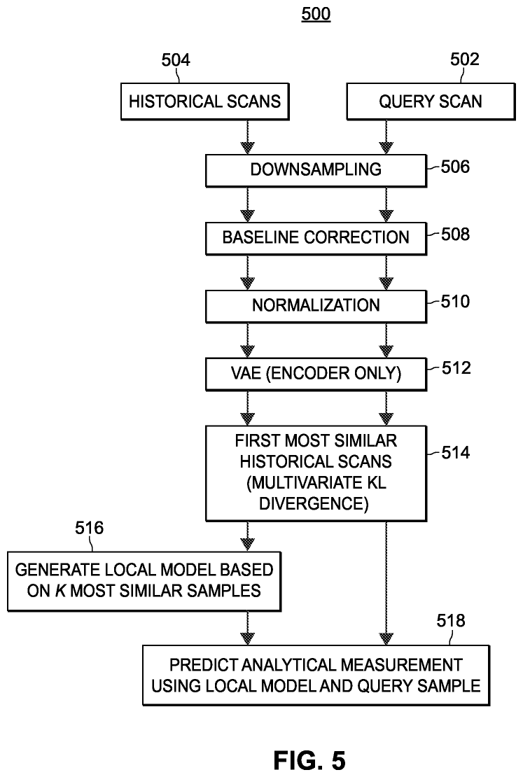

FIG. 5 depicts an example VAE-JITL process 500 that may be implemented by computing system 110 of FIG. 1 or FIG. 2. For ease of explanation, the VAE-JITL process 500 will be explained with reference to the elements of FIGS. 1, 2, and 4. Process 500 may be implemented by VAE-JITL predictor application 130 of computing system 110, for example.

In the example process 500, when a new Raman scan vector (query scan 502) is captured (e.g., during run-time operation of bioreactor 102), query unit 140 (or another unit or application) processes each of a number of Raman scan vectors in observation databased 136 (historical scans 504), and the query scan, using the same three pre-processing steps: 1) downsampling the scan (stage 506); 2) baseline-correcting the downsampled scan (stage 508); and 3) normalizing the downsampled and baseline-corrected scan (stage 510). In other embodiments, one or more of stages 506, 508, 510 are omitted, additional stages are included, and/or the stages 506, 508, and/or 510 occur in a different order than shown in FIG. 5.

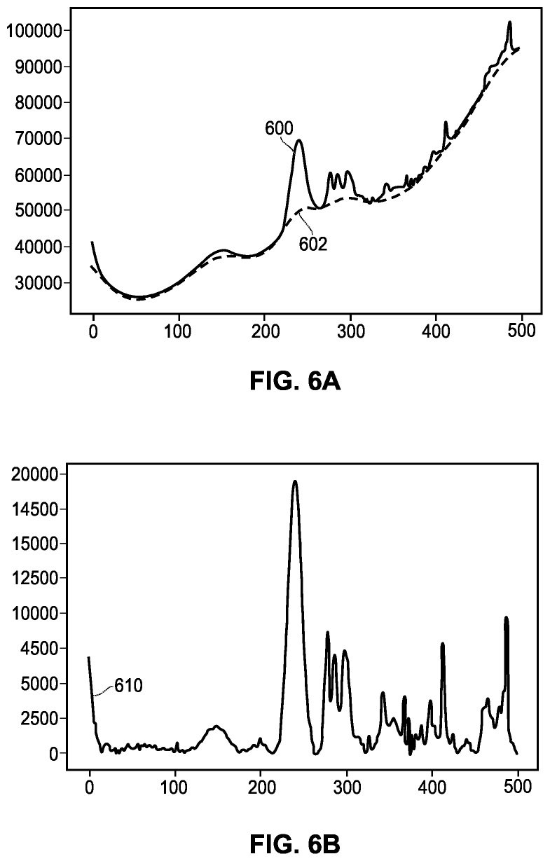

An example of baseline correction, such as that which may occur at stage 508, is shown in FIGS. 6A and 6B. Raman spectroscopy provides detailed spectroscopic fingerprint information about the molecules in bioreactors such as bioreactor 102. However, the uncertainties in the scanning process normally results in blurring baselines, which impacts the precision in quantitative analysis. To extract more refined information from raw Raman spectra, baseline correction can be an important step. Due to overlapped peaks and strong nonlinearity in Raman data, however, capturing a baseline with polynomial fitting is a non-trivial task. Recently, a combination of penalized spline smoothing algorithm and vector transformation strategy has been proposed to preserve the background signals. This algorithm fits a function as a combination of B-splines by minimizing a regularized least square objective function to the Raman data. See Yao-yi et al., Analytical Methods, 10, 3525-3533, Baseline Correction for Raman Spectra Using Penalized Spline Smoothing Based on Vector Transformation (2018).

FIG. 6A shows a downsampled Raman scan 600 (e.g., downsampled by a factor of 4 or 5), where the x-axis represents the feature number (i.e., the Raman shift after downsampling), and the y-axis represents intensity. The downsampling at stage 506 may occur after query unit 140 truncates the Raman scan down to a range that removes noise and/or other undesired phenomena (e.g., for 3344 features/Raman shifts in the original scan, selecting only the range of 500-3000, or 600-1800, etc.). Query unit 140 applies the smoothing algorithm (e.g., penalized spline smoothing) to the downsampled Raman scan 600 to generate the baseline Raman scan 602. By subtracting the baseline Raman scan 602 from the Raman scan 600, query unit 140 generates the baseline-corrected Raman scan 610 shown in FIG. 6B.

Referring now back to FIG. 5, query unit 140 may apply the normalization at stage 510 using min-max normalization, for example. The min-max normalization may be based on minimum and maximum values for specific experiments or across all experiments. In other embodiments, other suitable types of normalization are used. Query unit 140 (or another unit or application) may also or instead apply other pre-processing steps not shown in FIG. 5. For example, as noted above, the Raman scan may be truncated prior to (or after) downsampling. As another example, certain historical data sets from observation database 136 are not used by query unit 140. This may be needed, for example, if certain experiments used particular filters that drastically altered the Raman scan signals.

At stage 512, query unit 140 applies the pre-processed data (each of historical scans 504, and query scan 502) as an input to encoder 402 of VAE 400, in order to extract the dominant features as represented by the distribution parameters 426. At stage 514, query unit 140 uses the encoder 402 outputs (i.e., distribution parameters 426) to find the scans of historical scans 504 (after processing at stages 506, 508, 510, 512) that are most similar to the query scan 502 (also after processing at stages 506, 508, 510, 512). In particular, query unit 140 determines similarity based on the distribution parameters 426 of each of the historical scans 504 and the distribution parameters 426 of the query scan 502. In some embodiments, query unit 140 accomplishes this using multivariate KL divergence (e.g., as in Equation 2 above).

At stage 516, local model generator 142 generates/calibrates local model 132 (e.g., a Gaussian process model) based on the K most similar samples, where K is any suitable positive integer. At stage 518, prediction unit 144 predicts an actual measurement (e.g., a specific metabolite concentration, or VCD, or titer, etc.) using local model 132 and the query scan 502. That is, prediction unit 144 applies query scan 502 (after the pre-processing at stages 506, 508, 510) as an input to the trained/calibrated local model 132.

In some embodiments, all stages shown in FIG. 5 occur during run-time operation of bioreactor 102, e.g., with both the query scan 502 and the historical scans 504 being processed (stages 506, 508, 510, 512) after the new query scan 502 is obtained by Raman analyzer 106 and sent to computing system 110. In other embodiments, the historical scans 504 are processed in an offline manner (e.g., prior to run-time operation of bioreactor 102) at stages 506, 508, 510, 512, while all other operations (i.e., processing of the query scan 502 at stages 506, 508, 510, 512, as well as stages 514, 516, 518) are performed after the new query scan 502 is obtained by Raman analyzer 106 and sent to computing system 110.

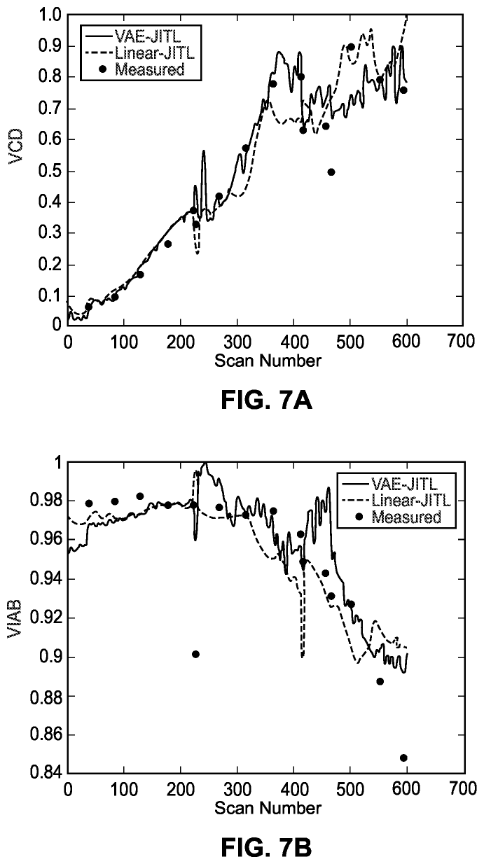

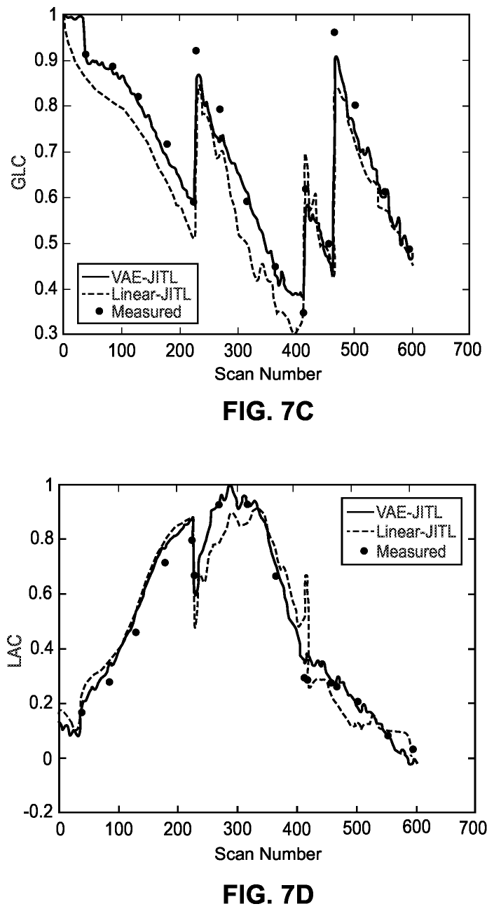

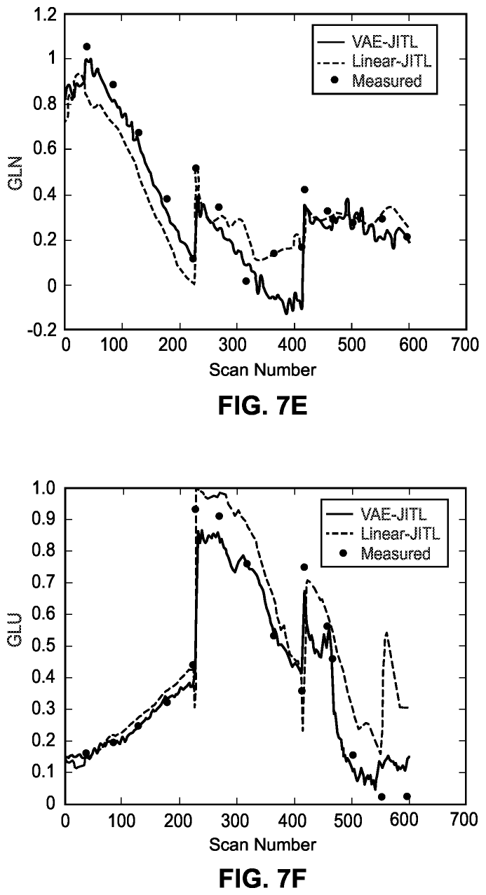

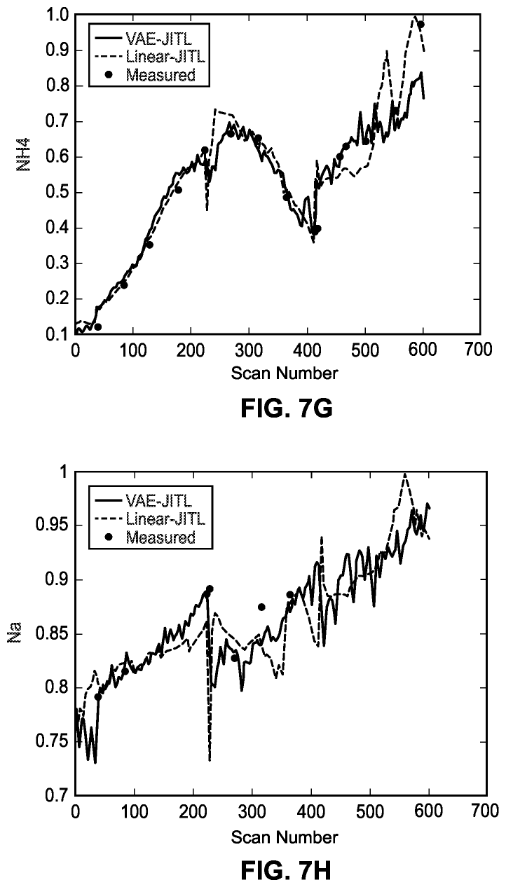

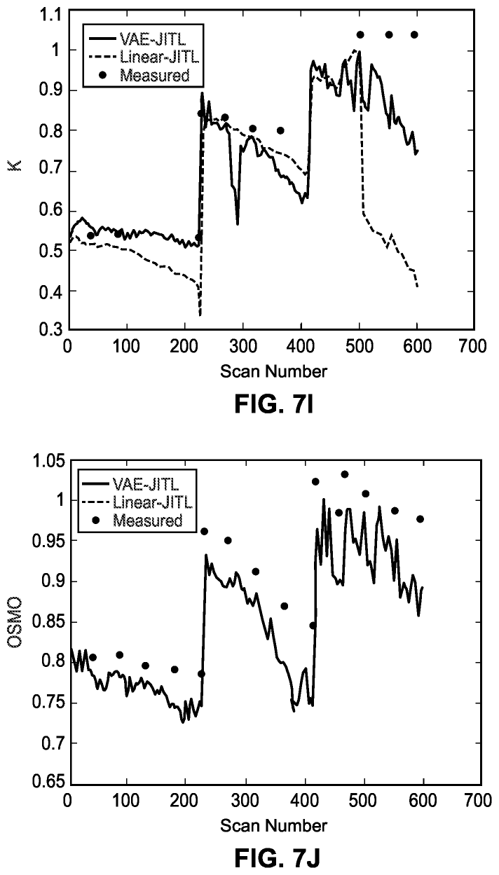

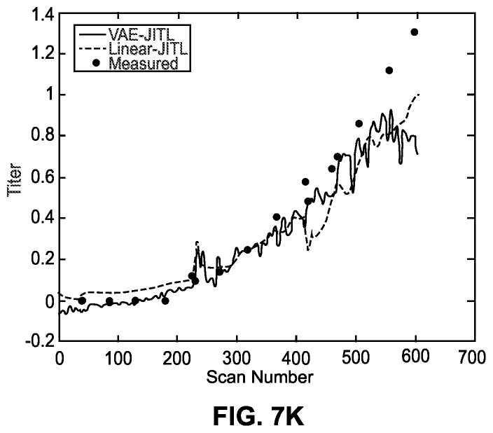

FIGS. 7A-J depict examples of VAE-JITL prediction performance (as obtained using an embodiment of the invention disclosed herein) relative to linear JITL (“Linear-JITL”) prediction performance and measured values, for various types of analytical measurements. To compare the performances of Linear-JITL and (one embodiment of) VAE-JITL, a validation study was performed with the same historical data and same local model. Both VAE-JITL and Linear-JITL used the same JITL framework, except for the technique for identifying similar scans/sample. The Linear-JITL predictions use a K-nearest neighbor approach with a Euclidean distance metric to find historical scans that are most similar to the query scan, while VAE-JITL used distribution parameters generated by a VAE encoder, and multivariate KL divergence metrics, to find the most similar historical scans. In each of FIGS. 7A-J, the y-axis of the figure is normalized with respect to the maximum value of the predictions, and the x-axis represents the number of the Raman scans in the time-order in which the scans were obtained.

The performance of both VAE-JITL and Linear-JITL was determined offline by calculating root-mean-square-error (RMSE) and mean-absolute-percentage-error (MAPE). These two metrics are standard methods for measuring the difference between actual analytical measurements and model predictions. The RMSE is calculated as

$$R M S E = \sqrt{\frac{1}{{T}^{q}} {\sum }_{t = 1}^{{T}^{q}} {( {y}_{t} - {y}_{t}^{q} )}^{2}} \qquad ( Equation 3 )$$

and the MAPE is computed as

$$M A P E = \frac{1}{{T}^{q}} {\sum }_{t = 1}^{{T}^{q}} \vert \frac{{y}_{t} - {y}_{t}^{q}}{{y}_{t}} \vert \qquad ( Equation 4 )$$

In order for VAE training and Gaussian process local model development, Raman features between specific (and identical) ranges were used, and the data was downsampled by a factor of 5. Moreover, the VAE was selected as a two-layer neural network with 260 units/nodes in the input layer and 128 units/nodes in the (single) hidden layer. The activation function in the hidden layer was Relu and the VAE was trained for 20 epochs. In other embodiments or applications, the VAE may be trained for a different number of epochs, and/or a different activation function may be used. The number of nearest samples used for Gaussian process local model development (i.e., K) was 100.

FIG. 7A illustrates the predictive performance of VAE-JITL against Linear-JITL for the key variable of viable cell density (VCD). In FIG. 7A, it can be seen that both algorithms have similar performance at the beginning of the batch. However, the VAE-JITL predictions more closely follow the actual analytical measurements while the Linear-JITL predictions deviated from the offline measurement in the middle of the batch (between the scan numbers 350 and 450). At scan number 470, both models failed to match the offline measurement, and at about scan number 500, Linear-JITL had a better prediction than VAE-JITL.

FIGS. 7C and 7K compare predictive performance for the other key variables of glucose concentration (GLC) and titer, respectively. In each case, a similar performance improvement can be observed in VAE-JITL predictions relative to Linear-JITL predictions. FIG. 7C, in particular, clearly shows that predictions of VAE-JITL are much closer to the actual analytical measurements, while Linear-JITL predictions track the measurements with an undesired bias. In FIG. 7K, performance is similar, but both VAE-JITL and Linear-JITL fail to “catch up” to actual measurements near the end of the batch. The reason for this is that the historical batches rarely had titer values above 1, and as a result, both techniques were unable to extrapolate predictions.

FIGS. 7D, 7I, and 7J represent the prediction trajectories for lactate concentration (LAC), potassium concentration (K), and osmolality (OSMO), respectively. FIGS. 7D and 7I confirm that VAE-JITL is better than Linear-JITL at predicting LAC and K. However, FIG. 7J indicates that VAE-JITL does not necessarily give better predictions than Linear-JITL for all metabolites. FIG. 7J also shows that both models provide good predictions of the OSMO trajectory, but suffer from bias relative to the offline measurements.

FIGS. 7B, 7E, 7F, 7G, and 7H compare predictive performance for viability (VIAB), glutamine concentration (GLN), glutamate concentration (GLU), ammonium concentration (NH4), and sodium concentration (Na), respectively.

In order to compare the JITL algorithms quantitatively, the RMSE and MAPE of the predictions of certain bioprocess variables with respect to their corresponding measurement are represented in Table 1 below. These values confirm that VAE-JITL generally provides better performance than Linear-JITL. However, the RMSE and MAPE of OSMO show that VAE-JITL may not be superior to Linear-JITL in all cases.

TABLE 1

| | |
|---|---|
| VAE-JITL | Linear-JITL |

| Property | RMSE | MAPE | RMSE | MAPE |
|---|---|---|---|---|
| VCD | 10.308 | 0.1093 | 12.833 | 0.1726 |
| VIAB | 2.403 | 0.0173 | 3.276 | 0.0233 |
| GLC | 0.873 | 0.0638 | 1.357 | 0.1281 |
| LAC | 0.140 | 0.1883 | 0.355 | 0.2977 |
| GLN | 0.660 | 0.575 | 0.724 | 1.0617 |
| NH4 | 0.4013 | 0.616 | 0.736 | 1.613 |
| Na | 3.128 | 0.0222 | 6.657 | 0.0431 |
| K | 3.500 | 0.0894 | 8.055 | 0.2027 |
| OSMO | 26.972 | 0.0682 | 26.992 | 0.0537 |
| Titer | 0.388 | 0.1068 | 0.396 | 0.5018 |

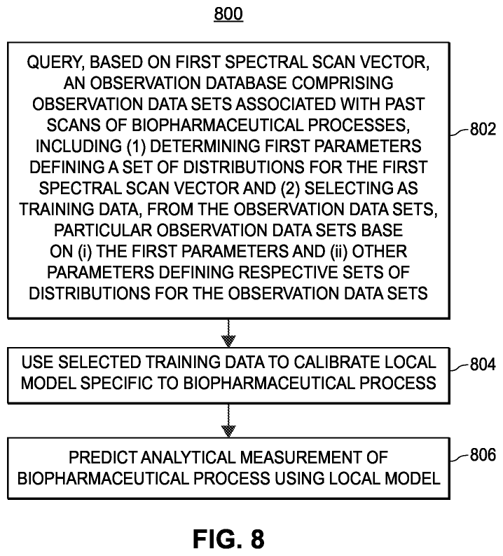

FIG. 8 is a flow diagram of an example method 800 for analyzing a biopharmaceutical process using VAE-JITL (e.g., for monitoring and/or control purposes). The method 800 may be implemented by a computer such as computing system 110 of FIG. 1 or FIG. 2 (e.g., by processing unit 120 executing instructions of VAE-JITL predictor application 130), for example.

At block 802, an observation database (e.g., observation database 136) comprising a plurality of observation data sets associated with past scans of biopharmaceutical processes is queried based on a first spectral scan vector of the biopharmaceutical process obtained by a spectroscopy system (e.g., Raman analyzer 106 and Raman probe 108). Each of the observation data sets includes spectral data (e.g., a Raman scan vector) and a corresponding actual analytical measurement (e.g., any one of the variables shown in Table 1). The querying at block 802 includes determining first parameters defining a set of distributions for the first spectral scan vector (e.g., mean and variance values for a set of normal or approximately normal distributions) using an encoder of a VAE (e.g., encoder 402 of VAE 400). The querying also includes selecting as training data, from among the plurality of observation data sets, particular observation data sets based on the first parameters, and further based on other parameters defining respective sets of distributions for the plurality of observation data sets (e.g., means and variances for sets of normal (or approximately normal) distributions, with each set of distributions corresponding to a different observation data set).

Selecting the particular observation data sets as training data at block 802 may include calculating multivariate KL divergence metrics based on the first parameters and the other parameters (e.g., as in Equation 2). In some embodiments, block 802 also includes pre-processing the first spectral scan vector prior to determining the first parameters (e.g., as in stage(s) 506, 508, and/or 510 of FIG. 5), in which case the spectral data of the plurality of observation data sets was similarly pre-processed (i.e., prior to the generation of the distribution sets for the plurality of observation data sets).

At block 804, the selected training data is used to calibrate a local model specific to the biopharmaceutical process (e.g., local model 132).

At block 806, an analytical measurement of the biopharmaceutical process is predicted using the local model. The analytical measurement may be any one of the variables in Table 1, such as a metabolite concentration, or viability, VCD, osmolality, or titer, or another suitable type of analytical measurement, for example. The analytical measurement is the same type of measurement used as labels when training the local model at block 804.

In some embodiments, the method 800 includes one or more additional blocks not shown in FIG. 8. For example, the method 800 may include an additional block in which at least one parameter of the biopharmaceutical process is controlled, based at least in part on the analytical measurement predicted at block 806. Depending on the embodiment, the parameter may be of the same type as the predicted analytical measurement (e.g., controlling a glucose concentration based on a predicted glucose concentration), or of a different type. Model predictive control (MPC) techniques may be used to control the parameter (or parameters), for example.

As another example, the method 800 may include a first additional block in which a user interface (e.g., presented on display 124) is caused to display the predicted analytical measurement. As yet another example, the method 800 may include one or more additional sets of blocks, each similar to blocks 802 through 806. In each of these additional sets of blocks, a local model may be calibrated by querying the observation database (or another observation database), and used to predict a different type of analytical measurement.

Additional considerations pertaining to this disclosure will now be addressed.

Some of the figures described herein illustrate example block diagrams having one or more functional components. It will be understood that such block diagrams are for illustrative purposes and the devices described and shown may have additional, fewer, or alternate components than those illustrated. Additionally, in various embodiments, the components (as well as the functionality provided by the respective components) may be associated with or otherwise integrated as part of any suitable components.

Embodiments of the disclosure relate to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Python, Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

As used herein, the singular terms “a,” “an,” and “the” may include plural referents, unless the context clearly dictates otherwise.

As used herein, the terms “connect,” “connected,” and “connection” refer to an operational coupling or linking. Connected components can be directly or indirectly coupled to one another, for example, through another set of components.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes, tolerances and/or other reasons. There may be other embodiments of the present disclosure which are not specifically illustrated. The specification (other than the claims) and drawings are to be regarded as illustrative rather than restrictive. Modifications may be made to adapt a particular situation, material, composition of matter, technique, or process to the objective, spirit and scope of the present disclosure. All such modifications are intended to be within the scope of the claims appended hereto. While the techniques disclosed herein have been described with reference to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

1. A computer-implemented method for monitoring and/or controlling a biopharmaceutical process, the method comprising:
querying, by one or more processors and based on a first spectral scan vector of the biopharmaceutical process obtained by a spectroscopy system, an observation database comprising a plurality of observation data sets associated with past scans of biopharmaceutical processes, wherein each of the observation data sets includes spectral data and a corresponding actual analytical measurement, and wherein querying the observation database includes
determining first parameters defining a set of distributions for the first spectral scan vector, and
selecting as training data, from among the plurality of observation data sets, particular observation data sets based on (i) the first parameters and (ii) other parameters defining respective sets of distributions for the plurality of observation data sets;
calibrating, by the one or more processors and using the selected training data, a local model specific to the biopharmaceutical process, the local model being trained to predict analytical measurements based on spectral data inputs; and
predicting, by the one or more processors, an analytical measurement of the biopharmaceutical process, wherein predicting the analytical measurement of the biopharmaceutical process includes using the local model to analyze spectral data that the spectroscopy system generated when scanning the biopharmaceutical process.

2. The computer-implemented method of claim 1, wherein determining the first parameters includes processing the query sample using an encoder of a variational autoencoder, and wherein the encoder outputs the first parameters.

3. The computer-implemented method of claim 2, wherein the encoder includes exactly one hidden layer.

4. The computer-implemented method of claim 2 or 3, further comprising:
determining, by the one or more processors, the other parameters using the encoder of the variational autoencoder, wherein the encoder outputs the other parameters.

5. The computer-implemented method of any one of claim 1, wherein selecting the particular observation data sets includes calculating multivariate KL divergence metrics based on the first parameters and the other parameters.

6. The computer-implemented method of claim 1, wherein calibrating the local model specific to the biopharmaceutical process includes:
calibrating a Gaussian process machine learning model specific to the biopharmaceutical process.

7. The computer-implemented method of claim 1, wherein:
querying the observation database includes downsampling the first spectral scan vector; and
using the local model to analyze the spectral data includes downsampling the spectral data.

8. The computer-implemented method of claim 7, wherein:
querying the observation database includes baseline-correcting the downsampled first spectral scan vector; and
using the local model to analyze the spectral data includes baseline-correcting the downsampled second spectral data.

9. The computer-implemented method of claim 8, wherein:
querying the observation database includes normalizing the downsampled and baseline-corrected first spectral scan vector; and
using the local model to analyze the spectral data includes normalizing the downsampled and baseline-corrected spectral data.

10. The computer-implemented method of claim 1, wherein using the local model to analyze the spectral data includes using the local model to analyze the first spectral scan vector.

11. The computer-implemented method of claim 1, wherein the predicted analytical measurement of the biopharmaceutical process is a metabolite concentration.

12. The computer-implemented method of claim 1, wherein the predicted analytical measurement of the biopharmaceutical process is osmolality, viability, viable cell density, or titer.

13. The computer-implemented method of claim 1, wherein the spectroscopy system is a Raman spectroscopy system.

14. The computer-implemented method of claim 1, further comprising:
controlling, by the one or more processors and based on the predicted analytical measurement of the biopharmaceutical process, at least one parameter of the biopharmaceutical process.

15. The computer-implemented method of claim 1, further comprising:
causing, by the one or more processors, a user interface to display the predicted analytical measurement.

16. A spectroscopy system comprising:
one or more spectroscopy probes collectively configured to (i) deliver source electromagnetic radiation to a biopharmaceutical process and (ii) collect electromagnetic radiation while the source electromagnetic radiation is delivered to the biopharmaceutical process; and
a computing system having one or more processors configured to:
query, based on a first spectral scan vector of the biopharmaceutical process obtained by the spectroscopy system, an observation database comprising a plurality of observation data sets associated with past scans of biopharmaceutical processes, wherein each of the observation data sets includes spectral data and a corresponding actual analytical measurement, and wherein querying the observation database includes:
determining first parameters defining a set of distributions for the first spectral scan vector, and
selecting as training data, from among the plurality of observation data sets, particular observation data sets based on (i) the first parameters and (ii) other parameters defining respective sets of distributions for the plurality of observation data sets;
calibrate, using the selected training data, a local model specific to the biopharmaceutical process, the local model being trained to predict analytical measurements based on spectral data inputs; and
predict an analytical measurement of the biopharmaceutical process, wherein predicting the analytical measurement of the biopharmaceutical process includes using the local model to analyze spectral data that the spectroscopy system generated when scanning the biopharmaceutical process.

17. A non-transitory computer-readable medium storing instructions that, when executed by one or more processors, cause the one or more processors to:
query, based on a first spectral scan vector of the biopharmaceutical process obtained by the spectroscopy system, an observation database comprising a plurality of observation data sets associated with past scans of biopharmaceutical processes, wherein each of the observation data sets includes spectral data and a corresponding actual analytical measurement, and wherein querying the observation database includes:
determining first parameters defining a set of distributions for the first spectral scan vector, and
selecting as training data, from among the plurality of observation data sets, particular observation data sets based on (i) the first parameters and (ii) other parameters defining respective sets of distributions for the plurality of observation data sets;
calibrate, using the selected training data, a local model specific to the biopharmaceutical process, the local model being trained to predict analytical measurements based on spectral data inputs; and
predict an analytical measurement of the biopharmaceutical process, wherein predicting the analytical measurement of the biopharmaceutical process includes using the local model to analyze spectral data that the spectroscopy system generated when scanning the biopharmaceutical process.
